(19) United States
(12) Patent Application Publication
(10) Pub. No.: US 2011/0316785 A1
(43) Pub. Date: Dec. 29, 2011

(54) KEYPAD FOR HAND-HELD DEVICES WITH TOUCH SCREENS

(76) Inventor: Murray HIDARY, New York, NY (US)

(21) Appl. No.: 13/170,145

(22) Filed: Jun. 27, 2011

Related U.S. Application Data
(60) Provisional application No. 61/358,471, filed on Jun. 25, 2010.

(51) Int. Cl. G06F 3/02

(52) U.S. Cl. 345/168

(57) ABSTRACT

An accessory device for providing a tactile response for users of hand-held devices with touch screens is provided. The accessory device includes a plurality of domes, each dome having an input member. When force is applied to a dome, the dome provides a tactile stimulus to the user and causes the input member to actuate a corresponding input of the touch screen.

### RELATED APPLICATIONS

This application claims priority under 35 U.S.C. §119(e) to U.S. Provisional Application No. 61/358,471, incorporated herein by reference in its entirety.

### FIELD OF THE INVENTION

This application relates to an accessory device for operating a touch sensitive screen keyboard.

### BACKGROUND OF THE INVENTION

Many smart phones, portable devices, computers and mobile phones have touch sensitive screens which have multiple purposes. First, they are used to present text and images to the users. Second, they present soft control keys that may be fixed or programmable to allow users to access and perform various functions of the devices. Third, they present a standard QWERTY and/or a numerical keyboard that can be used to enter data, including alphanumeric characters and other symbols. In other words, very often these kinds of devices present a virtual keyboard for data and text entry.

However, for many users, a virtual keyboard is unsatisfactory and difficult to use, especially, if a long document with many characters is to be entered. The main objection to the virtual keyboard is that the touch screen fails to provide a tactile feedback to a user similar to the feedback received from a a dedicated keyboard with actual keys (or switches) that provide some resistance when the keys are pressed.

### SUMMARY OF THE INVENTION

The present invention overcomes this problem by providing an accessory. The main portion of the accessory is a keypad in the form of a sheet of plastic material that has the same size and shape as the virtual keyboard, optionally with a peripheral edge for holding the sheet in place. The dimension and size of the keypad is customized so that different sheets can be provided for IPads, Iphones, Ipods, Palms, etc. Importantly, the sheet is formed with an array of bumps sized and shaped so that each bump is positioned over and is in register with a matching virtual key on the keyboard displayed on the touch screen. The bump is preferably dome shaped and is integrally formed with the sheet in such a manner as to imitate at least partially a key on a keyboard. In other words, a user can push on a bump and feel it actually move by at least one or more millimeters before it bottoms at or near the surface of the touch screen thereby providing a tactile feedback to the user. Depending on the type of touch screen being used, the bump can be made of a regular soft plastic material such as a rubber vinyl, or a silicone material, or it may be of or include an electrically conductive element sized and shaped so that when the respective bump is pushed with the finger, the touch screen reacts exactly the way it would react when touched by the actual finger itself. Preferably the sheet and the bumps are transparent or highly translucent so that the indicia forming the virtual keyboard are clearly visible. Alternatively, or in addition, respective indicia may be imbedded, attached or printed on the sheet with bumps themselves.

The user installs the keypad over the virtual keyboard of the touch screen—the bumps forming an array that exactly matches in dimension the virtual keyboard, as discussed. The keypad would be made from a rubber vinyl or silicone material which would allow it to adhere to the screen temporarily without slipping. The keypad has raised keys for each key formed by the bumps. The material would be ideal for activating the touch screen sensitivity. The overlay keypad may also be built into protective sleeves or cases.

### BRIEF DESCRIPTION OF THE DRAWINGS

The above-described and other advantages and features of the present disclosure will be appreciated and understood by those skilled in the art from the following detailed description and drawings of which,

FIG. 1 is a perspective view of a first embodiment of the keypad of the present invention;

FIG. 2 is a cross section view thereof;

FIG. 3 is a further cross section view thereof, wherein the keypad has been activated; and

FIG. 4 is a cross section view of a second embodiment of the keypad of the present invention.

### DETAILED DESCRIPTION OF THE INVENTION

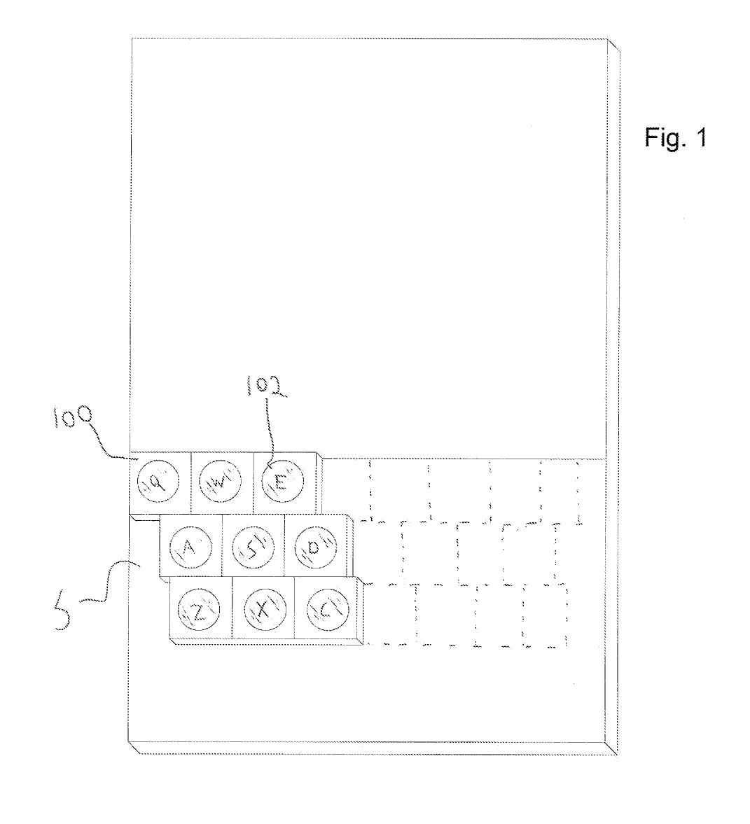

FIGS. 1 and 2 show a first preferred embodiment of the keypad device 100 of the present invention. The keypad device 100 includes domes 102 and input members 104. Domes 102 correspond to the location of inputs or “keys” on a touch screen of a hand-held electronic device. Input members 104 rest a small distance, preferably one millimeter above a screen S.

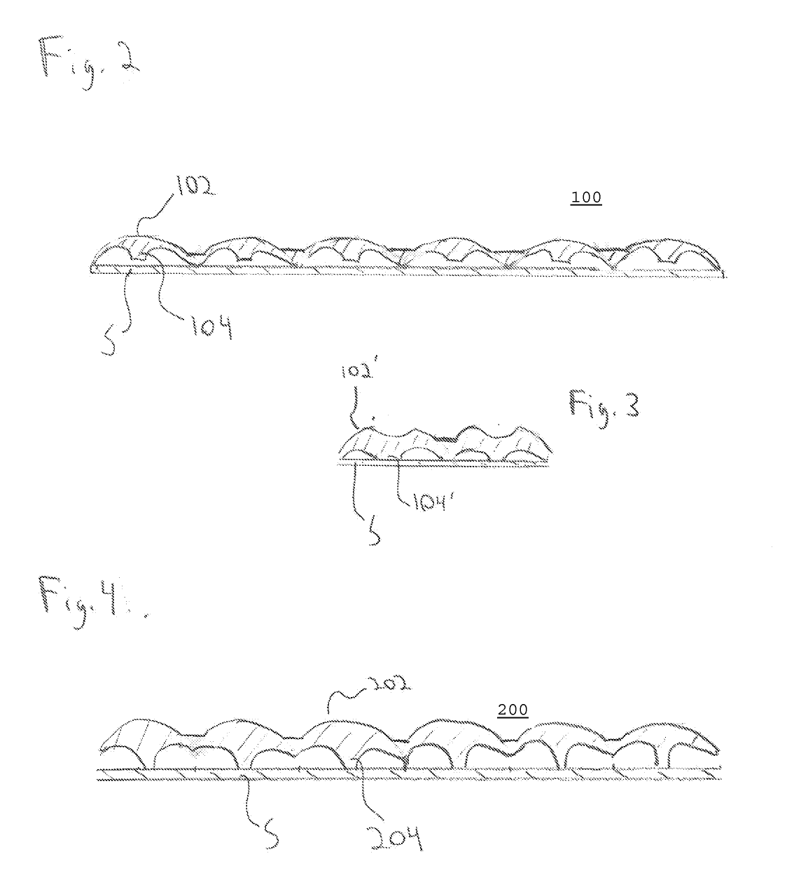

As shown in FIG. 3, when a force is applied to a dome 102, the corresponding input member 104 is pressed into screen S. Accordingly, the corresponding input on the touch screen S is actuated. At the same time, the deformation of the dome 102 causes a tactile response for the user who is applying the force.

FIG. 4 illustrates a second preferred embodiment of the present invention. In this embodiment, the device 200 is partitioned into a plurality of sections 204, each being electrically isolated from the other and each section 204 being in permanent contact with a respective section of the screen S. Touching a particular section 204 activates the virtual key below it.

In an alternative of the second preferred embodiment, sections 202 are not dome shaped, but are one of: box shaped and pointed.

In the embodiments described the screen S is responsive to an electrical contact and, consequently, devices 100, 200 are electrically conductive. Of course, the devices 100 and 200 may be made of a material such that they can activate a capacitive-type or inductive-type screen as well.

The accompanying drawings only illustrate one embodiment of a keypad for hand-held devices with touch screens blade and its respective constituent parts, however, other types and styles are possible, and the drawings are not intended to be limited in that regard. Thus, although the description above and accompanying drawings contains much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

1. A keypad device for operating hand-held devices having touch sensitive screens, comprising:
a body defining a plurality of touch sensitive areas, said areas corresponding to virtual images displayed on a touch sensitive screen;
wherein touching one of the sensitive areas causes the screen to react as if the screen itself was touched.

2. The device of claim 1 wherein said areas include domes and touching said domes being responsive to a force toward said screen when touched.

3. The device of claim 1 wherein said touch sensitive areas are electrically conductive

4. The device of claim 1 wherein said touch sensitive areas are capacitive.

5. The device of claim 1 wherein said touch sensitive areas are inductive.
